(19) United States
(12) Patent Application Publication
(10) Pub. No.: US 2012/0239436 A1
(43) Pub. Date: Sep. 20, 2012

(54) METHOD FOR DEFINING QUALIFIED DIRECT COST

(76) Inventor: Kenton C. Crabb, Munson, OH (US)

(21) Appl. No.: 13/419,278

(22) Filed: Mar. 13, 2012

Related U.S. Application Data
(63) Continuation-in-part of application No. 11/584,687, filed on Oct. 20, 2006, now abandoned.
(60) Provisional application No. 60/729,136, filed on Oct. 20, 2005.

(51) Int. Cl. G06Q 40/08

(52) U.S. Cl. 705/4

(57) ABSTRACT

An insurance product provides death benefits to employees of an employer. The product includes an irrevocable trust and a participating whole life insurance policy, wherein the participating whole life insurance policy is owned by the irrevocable trust. The product also includes a restricted property agreement, the terms of the agreement providing that contributions will be made to the trust sufficient to cover at least a base policy premium of the whole life insurance policy for a designated period of time, wherein the base policy premium of the whole life insurance policy constitutes a qualified direct cost.

### CROSS REFERENCE TO RELATED APPLICATIONS

This application is a continuation-in-part of U.S. patent application Ser. No. 11/584,687 filed Oct. 20, 2006, which application claims the benefit of U.S. Provisional Patent Application Ser. No. 60/729,136 titled METHOD FOR DETERMINING QUALIFIED COST and filed on Oct. 20, 2005. The contents of the foregoing applications are incorporated herein by reference.

### BACKGROUND OF THE INVENTION

1) Field of the Invention

A system and method for determining Qualified Direct Cost is provided, and more particularly, a system and method for determining Qualified Direct Cost within the meaning of the Internal Revenue Code Section 419(c)(3) without creating a reserve is provided.

2) Description of Prior Art

Various types of life insurance exist. Term life insurance provides coverage at a fixed rate of payments for a limited period of time, the relevant term. After that period expires, coverage at the previous rate of premiums is no longer guaranteed and the client must either forego coverage or obtain further coverage with potentially different payments and/or conditions.

Whole life insurance is a life insurance policy that remains in force for the insured's whole life and require premiums to be paid every year into the policy. If the full base premium is not paid, the policy will either lapse or automatically be dramatically reduced, by contract, to a reduced-paid-up policy. In a participating whole life insurance policy, each year, the insurance company pays out dividends that can be allocated to an investment component or to purchase further insurance. Dividend options vary across policies and insurance companies. However, the insured does not determine how the investment component is invested.

Universal life insurance is a type of permanent life insurance based on a cash value. The premium payments in a universal life insurance policy are very flexible. The cost of insurance (COI) must be maintained and then as much or as little can be contributed to the investment component. Payors in a universal life contract are only required to pay the current cost of insurance as shown in the COI portion of the contract. This amount is typically equal to the annual renewable term cost. If the premium is not paid the company will automatically take the premium from the cash value and the full death benefit will stay in-force. Thus, in a universal life insurance policy, there is no base policy premium.

### BRIEF SUMMARY OF THE INVENTION

A computer system is provided to manage an insurance product, the computer system includes: a processor; and a memory communicatively coupled to the processor, wherein the processor is configured the manage an insurance product, the insurance product providing death benefits to employees of an employer and comprising: an irrevocable trust created by the employer; a participating whole life insurance policy, the whole life insurance policy being owned by the irrevocable trust; and a restricted property agreement between the employer and at least one of the employees, terms of the agreement providing that contributions will be made by the employer to the trust sufficient to cover at least a base policy premium of the whole life insurance policy for a designated period of time, the base policy premium being the amount of premium necessary to maintain the whole life insurance policy; and wherein the processor is configured to determine a qualified direct cost by combining the participating whole life insurance policy in which the base policy premium is required to be paid each year to keep the whole life insurance policy in force and is an amount equal to a required annual payment by the irrevocable trust to pay a current cost of the death benefits and insuring an employee's life each year of participation.

A system is provided under which an insurer will provide death benefits to employees of an employer, the system includes: a participating whole life insurance policy configured to provide death benefits to an employee under a single welfare benefit plan, the participating whole life insurance policy having a contract premium and a paid-up addition; a qualified direct cost based solely on the contract premium, the qualified direct cost being an amount equal to a required annual payment to pay a current cost of the death benefits established by the whole life insurance policy; and a trust agreement between the employer and employee, wherein the employer provides welfare benefits to the employee and to designated beneficiaries of the employee through the trust agreement.

An insurance product is provided under which an insurer provides death benefits to an employee of an employer, comprising: at least one irrevocable welfare benefit trust, the at least one trust being funded with a contribution from the employer; a whole life insurance policy owned by the at least one trust, wherein a base premium cost of the policy qualifies as a qualified direct cost within the meaning of IRC Section 419(c)(3); and a restricted property agreement executed between the employer and the employee, wherein the employee incurs a substantial risk of forfeiture within the meaning of IRC Section 83.

### BRIEF DESCRIPTION OF THE DRAWINGS

FIG. 1 illustrates a diagram that shows how Qualified Direct Cost can be determined.

### DESCRIPTION OF EXAMPLE EMBODIMENTS

The present system combines a participating whole life insurance policy with a restricted property agreement. In a participating whole life insurance policy, the insurance company shares excess profits, such as dividends or refunds, with the policy holder. These excess profits are considered an overcharge of premium. The greater the overcharge by the company, the greater the dividend/refund. The dividends, or refunds, are paid in cash and can be used to reduce premium payments or to purchase paid up additional insurance, which will increase the face amount of coverage. In contrast, in a non-participating whole life insurance policy, there is fixed premium throughout the life of the insured. No dividends or refunds are paid.

A 419(e) life insurance plan includes an irrevocable welfare benefit trust that qualifies under IRC 419(e), as amended, created as a welfare benefit fund. To create the trust, a trust agreement is executed and funded with a contribution. The trust is the mechanism through which welfare benefits are provided to employees and designated beneficiaries of the employees. In this plan, the welfare benefits provided are the death benefits paid from a life insurance policy owned by the trust. The trust consists of two funds—a welfare benefit fund which represents the funds necessary to provide the death benefit coverage and a non-welfare benefit fund that represents Section 83 property.

Having established that the trust was created for the purpose of providing a welfare benefit to employees (e.g., a death benefit), the next issue concerns the deductibility of the employer contributions to the trust. To be deductible for Federal income tax purposes, the contributions must otherwise be deductible under the IRC (e.g., under Section 162); but, the deduction is limited to the amount allowed under Section 419(b). With regard to the requirement that the contributions are otherwise deductible under the IRC, Treasury Regulation 1.162-10(a) expressly provides that amounts paid for a welfare benefit plan are deductible under Section 162(a) if such amount is an ordinary and necessary expense of the trade or business. It is recognized that such expenses incurred to fund an employee death benefit plan are ordinary and necessary business expenses.

Section 419(b) provides that the deduction allowed for contributions by an employer to a welfare benefit fund is limited to an amount that is not in excess of the welfare benefit fund's “Qualified Cost” for the taxable year. Then at Section 419(c), Qualified Cost is defined to mean the sum of the “Qualified Direct Cost” for such taxable year and any addition to a “Qualified Asset Account” for the taxable year (not applicable to the trust). Congress limited the deductibility of contributions by an employer to a welfare benefit fund to prevent employers from utilizing welfare benefit funds as repositories for advanced funding of benefits. In other words, in the absence of the limitation described in Section 419(b), employers would make large current contributions to a welfare benefit fund and take current deductions, even if the benefit provided applies to later years.

Under the plan, the funds contributed to the welfare benefit fund are intended to qualify as Qualified Direct Cost within the meaning of IRC Section 419(c)(3). As defined in the statute (e.g., IRC Section 419(c)(3)), Qualified Direct Cost means the aggregate amount (including administrative expenses) which would have been allowable as a deduction to the employer with respect to the benefits provided during the taxable year, if: (1) the employer provided the benefit directly to the employee; and (2) the employer used a cash method of accounting. A benefit is deemed provided when the benefit would have been includible in the income of the employee (but for provisions in Chapter One, Subtitle A of the IRC which excludes the benefit from gross income). IRC Section 419(c)(3)(B). The Qualified Direct Cost, in the context of a fully insured welfare benefit fund, is the cost of the life insurance for the period in which the coverage is provided. Stated differently, the amount of the Qualified Direct Cost for a taxable year of the welfare benefit fund includes payments by the fund for the cost of that year's employee death benefit coverage (plus any administrative expenses associated therewith).

Section 419(c)(3), expressly provides in the definition of Qualified Direct Cost that administrative expenses incurred in the provision of the welfare benefits is allowed as a deduction in the current year. Therefore, to the extent a portion of the premium to be paid by the employer in the context of the plan is for the payment of the current year life insurance protection and the administrative expenses associated therewith, then that amount of the premium is able to be deducted under Section 162 as an ordinary and necessary business expense and such amount is within the limitation described in Section 419(b) concerning the deductibility of contributions to welfare benefit plans.

It is noted that if the life insurance policy used to fund the welfare benefit involves levelized premiums, the levelized rate reasonably relates to the costs of the insurance coverage and related administrative expenses for the current year. Otherwise, this may cause a portion of the contribution to be capitalized. Where the benefits under the plan relate primarily to the well-being of employees and where the employer has relinquished sufficient control over the contribution such that the employer cannot direct the disposition of the funds prior to their use in paying benefits, no capitalization of the expenditures is required.

The Qualified Direct Cost will be established in an insurance contract. In the context of a whole life policy, it is assumed that the annual base premium cost represents the cost or death benefit coverage and associated administrative expenses for that year. Thus, the portion of the contribution equal to the premium base cost will equal the Qualified Direct Cost. The portion of the contribution allocable to paid-up additions will constitute the transfer of property to the employee within the meaning of IRC Sections 402 and 83.

The corporation's contribution to the trust will consist of two components: a Qualified Direct Cost and the transfer of Section 83 property. It is assumed that the portion of the contribution attributable to the annual base premium cost will be the Qualified Direct Cost and the portion of the contribution attributable to the paid-up additions will be Section 83 property.

At the corporate level, the corporation will deduct the Qualified Direct Cost portion under IRC Section 162 and 419. The Section 83 property portion will be deducted by the corporation pursuant to IRC Section 162 and 83(h), assuming the employee makes an effective Section 83(b) election (as discussed below).

At the employee level, the Section 83 property contribution will generally not be taxable to the employee since the employee's rights to the funds will not be substantially vested (e.g., right to benefit is subject to condition of providing substantial future services). However, it is contemplated that the employee will make a Section 83(b) election each year with respect to the transfer of the Section 83 property, thereby reporting it as current taxable income. Any future appreciation in value attributable to the Section 83 property will not be includible in the employee's income in the future. Further, since the employee is reporting the Section 83 property in current income under IRC Section 83(b), the corporation is entitled to a tax deduction under IRC Section 83(h).

With regard to the portion of the contribution relating to the cost of the current life insurance protection and administrative expenses, this contribution by the employer is subject to the split-dollar regulations under Treasury Regulation Section 1.61-22. Pursuant to Treasury Regulation Section 1.61-22(b)(2)(i),(ii), an arrangement is treated as a split-dollar life insurance arrangement if:
a The arrangement is entered into in connection with the performance of services;
b The employer or service recipient pays directly or indirectly all or any portion of the premium; and
c either, (i) the beneficiary of all or any portion of the death benefit is designated by the employee or (ii) the employee has any interest in the cash value of the policy.

The plan satisfies each of these requirements, such that the employer's contributions to the trust are subject to the split-dollar regulations. Therefore, the employee includes in gross income the value of the economic benefit provided by the plan. Pursuant to Treasury Regulation 1.61-22(d) the employee takes into account the full value of all economic benefits described in paragraph (d)(2) of this Section, reduced by the consideration paid directly or indirectly by the employee for those economic benefits. As described in Treasury Regulation Section 1.61-22(d)(2), the value of the economic benefits provided to the employee equals:
a The cost of current life insurance protection provided to the employee;
b The amount of the policy cash value to which the employee has current access (to the extent such amount was not actually taken into account for a prior taxable year); and
c Any economic benefits not described in (a) or (b), above, that are provided to the employee under the arrangement.

With regard to the cost of the current life insurance protection provided to the employee, the employee includes the Table 2001 Rate in gross income.

Upon termination of the trust or lapse of the substantial forfeiture restrictions, the policy will be distributed to the employee in-kind. The employee will include in taxable income the cash value of the policy less the Section 83 property as to which there is an 83(b) election and less the earnings traceable to the Section 83 property.

As an example, a single employer welfare benefit plan is provided. An irrevocable trust that qualifies under Section 419(e) as a “Welfare Benefit Fund” is created. An independent third party serves as the trustee of the irrevocable trust. The independent third party is an individual or entity that is unrelated to the employer. For instance, the independent third party can be a bank, trust company, or other separate company unrelated to the employer. The trust is a taxable trust. For Federal income tax purposes, the trust will be taxable under Subchapter J of the Tax Code. The employer makes a contribution to the trust each year for the purpose of providing death benefits to employees participating in a single employer welfare benefit plan.

The independent third party, or trustee, then uses the contributions from the employer to acquire a whole life insurance policy insuring the life of a participant in the plan. Thus, the trustee is the owner of the whole life insurance policy. As discussed below, the employee will have the right to designate the beneficiary of the policy. The life insurance policy will be a whole life policy.

As part of the single employer welfare benefit plan, the employer and each participating employee will execute a restricted property agreement under which the employee incurs a “substantial risk of forfeiture” (within the meaning of IRC Section 83) if the employee fails to work for the employer for an agreed upon period (e.g., number of years). Pursuant to the restricted property agreement, the employer will agree to pay the life insurance policy premium contributions to the trust. The primary purpose of the restricted property agreement is to create a substantial risk of forfeiture with respect to the “Section 83 property” transfer (as discussed below). However, in the event of the employee's death while employed, the employee's designated beneficiary will receive the death benefit. To be eligible for the plan, the employee cannot have majority control over the employer with respect to employer's ability to amend or terminate the plan.

In each year the plan is in existence, with regard to a specific employee, the employer will contribute the entire premium to the trust. This contribution will, in part, constitute the Qualified Direct Cost, or base policy premium, and, in part, constitute payment towards the cash value of the policy (e.g., paid-up additions). Failure to pay, at a minimum, the base policy premium during any year will cause the whole life insurance policy to lapse. The base policy premium represents the current cost of life insurance plus all administrative costs and expenses associated with the whole life insurance policy. The base policy premium is not supported by any additional premiums paid into the whole life insurance policy. This later portion of the contribution represents the “Section 83 property.” The employer will deduct for Federal income tax purposes the full amount of these contributions. The Qualified Direct Costs are deductible under IRC Sections 162 and 419, and the remaining premium contribution (i.e., the Section 83 Property) is deductible under IRC Section 83(h).

Assuming the employee makes a timely Section 83(b) election, the employer will report the amount contributed to the trust relating to the Section 83 property on the employee's W-2. Further, the employee will include the Table 2001 rate for the current cost of the life insurance protection in his/her gross income. As an aside, if the employee fails to make the Section 83(b) election, the Section 83 property transfer will not be currently taxable to the employee since the Section 83 property would be subject to substantial risk of forfeiture pursuant to the restricted property agreement. As a result of the Section 83(b) election, all future appreciation attributable to the Section 83 property will not be includible in income when it vests.

The amount of accumulation of the cash value of the policy is not currently included in the employee's gross income because the employee's right to the cash surrender value is subject to a substantial risk of forfeiture. To eliminate the imposition of a tax on the future appreciation attributable to the Section 83 property, the employee will make an 83(b) election, to currently include the Section 83 property in gross income. The risk of substantial forfeiture is that the employee's right to receive the policy is conditioned on performing substantial services for ten (10) years. If he fails to do so, the policy is distributed to the employee but he must reimburse the employer for the fair market value of the policy. As an aside, the policy cannot revert to the employer; in such event, a 100% excise tax would be imposed.

If the employee works for ten (10) years, the risk of forfeiture under the restricted property agreement will lapse and the trust will distribute the life insurance policy to the employee. The employee has to pay tax on the cash surrender value less the amount of the cash contribution previously included in the employee's gross income as a result of the Section 83(b) election and all appreciation related thereto. Also, if in any year of the plan, the employer contributes an amount to the trust in excess of the base policy premium, then the employee will make an election under IRC 83(b) to include such amount in gross income.

If the employee terminates employment before the agreed upon period of time (e.g., ten years) or if the plan is terminated prior to the end of that agreed upon period of time or if the employer fails to make any contribution to the trust during the term, then the trustee can distribute the life insurance policy to the employee, subject to the obligation that the employee must reimburse the employer the fair market value of the policy. Otherwise, the employee agrees that the life insurance policy owned by the trust will be forfeited to a charitable organization. To enforce the risk of forfeiture described in the restricted property agreement, the terms of the welfare benefit trust will contain provisions that if the trustee does not receive contributions from the employer in an amount sufficient to pay the base policy premium in each year, then the trustee is directed to transfer the whole life insurance policy to a charitable organization. The charitable organization is one as described in IRC section 501(c)(3). As stated above, the trust can contain provisions that if the failure to receive contributions in amounts sufficient to pay the base policy premium is on account of limited exceptions such as the disability of the employee then the risk of forfeiture will not apply and the trustee will be directed pursuant to the terms of the trust to transfer the whole life insurance policy to the employee.

The present insurance product treats the base policy premium akin to a term premium. The base policy premium is the amount of premium required to maintain the current death benefit, and with the use of the trust, any cash value attributable to the base premium is fully assigned from the death benefit trust to the restricted property trust. Thus, the base premium does not contribute to the cash value of the overall product and thus acts as a term premium that is the current cost of the current coverage.

If the employee dies while employed, then the employee's designated beneficiary will receive the insurance proceeds, without the imposition of any tax, or the obligation to reimburse the employer the fair market value of the policy. If no designated beneficiary exists, the trustee will pay the death benefits to the estate.

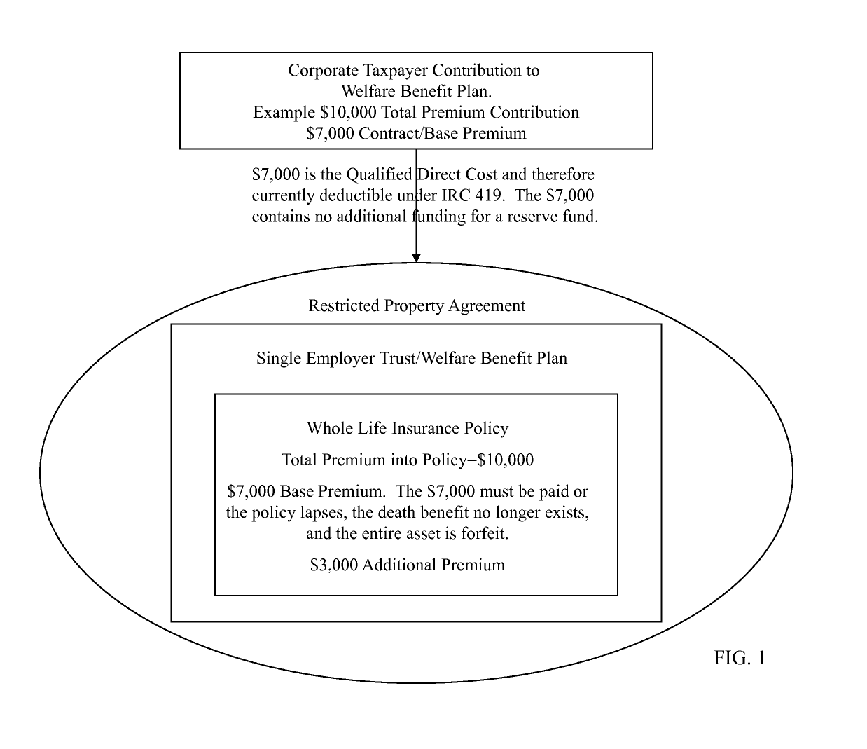

FIG. 1 illustrates a summary of how Qualified Direct Cost is determined. A whole life insurance policy combines a term policy with an investment component. A premium for a whole life insurance policy includes two parts. The first part is a contract or base premium, and the second part is any addition beyond the contract premium. This second part is usually referred to as a paid-up addition. In the present example, the total premium for the whole life insurance policy is $10,000. The base premium is $7,000 and the additional premium is $3,000. Some whole life insurance contracts provide that the entire contract premium, or the $7,000, must be paid in order to maintain the policy, or the policy will lapse. When an insurance policy lapses the coverage, e.g. death benefit, no longer exists. Therefore, in these types of whole life insurance contracts, the contract premium is the amount of premium attributable to the insurance coverage provided during the taxable year. The contract or base premium therefore defines the “Qualified Direct Cost”. In a Variable Universal Life insurance policy and in a Universal Life insurance policy, the premium attributable to insurance coverage is typically an adjustable renewable term premium. Therefore the Qualified Direct Cost is equal to mortality charges inside the insurance contract. Any larger current deduction creates a reserve under 419A(c)(2).

However, the owner of the whole life insurance policy, to maintain some death benefit, may change the contract and therefore the contract premium alone cannot fully define the current year's “Qualified Direct Cost”. Therefore in addition to the contract premium, a separate trust agreement is used to more clearly show that the entire contract premium is needed to maintain the existing life insurance coverage. When a restricted property agreement is used, and meets the requirements of having a substantial risk of forfeiture, within the meaning of IRC 83, this agreement requires that 100% of the contract/base premium is to be paid to the trust each year during the agreement, otherwise the life insurance policy is entirely forfeit. Therefore combining a whole life insurance policy contract premium and a restricted property agreement that meets the requirements set forth in IRC 83, in which the restricted property agreement requires 100% of the contract premium to be paid each year clearly defines a current “Qualified Direct Cost”.

All of the above steps can be performed by a programmable control device executing instructions organized into one or more program modules. A programmable control device may be a single computer processor, a special purpose processor (e.g., a digital signal processor, “DSP”), a plurality of processors coupled by a communications link or a custom designed state machine. Custom designed state machines may be embodied in a hardware device such as an integrated circuit including, but not limited to, application specific integrated circuits (“ASICs”) or field programmable gate array (“FPGAs”). Storage devices, sometimes called computer readable medium, suitable for tangibly embodying program instructions include, but are not limited to: magnetic disks (fixed, floppy, and removable) and tape; optical media such as CD-ROMs and digital video disks (“DVDs”); and semiconductor memory devices such as Electrically Programmable Read-Only Memory (“EPROM”), Electrically Erasable Programmable Read-Only Memory (“EEPROM”), Programmable Gate Arrays and flash devices.

It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

What is claimed is:

1. A computer system configured to manage an insurance product, the computer system comprising:
a processor;
and a memory communicatively coupled to the processor,
wherein the processor is configured the manage an insurance product that provides death benefits to employees of an employer, the insurance product comprising:
an irrevocable trust;
a participating whole life insurance policy, the whole life insurance policy being owned by the irrevocable trust; and
a restricted property agreement, wherein terms of the agreement provide that contributions will be made to the trust to cover at least a base policy premium of the whole life insurance policy for a designated period of time, the base policy premium being the amount of premium necessary to maintain the whole life insurance policy; and
wherein the processor is configured to determine a qualified direct cost by combining the participating whole life insurance policy in which the base policy premium is required to be paid each year to keep the whole life insurance policy in force and is an amount equal to a required annual payment by the irrevocable trust to pay a current cost of the death benefits and insuring an employee's life each year of participation.

2. The computer system of claim 1, wherein the irrevocable trust is owned by a third party unrelated to the employer.

3. The computer system of claim 1, wherein a term of the restricted property agreement provides that contributions will be made to the trust to cover the base policy premium.

4. The computer system of claim 1, wherein if the base policy premium is not paid during a predetermined time period, the whole life insurance policy is forfeited to a charitable organization.

5. The computer system of claim 1, wherein if the base policy premium is not paid by the trust during a predetermined time period, the whole life insurance policy is transferred to the insured.

6. The computer system of claim 1, wherein if an amount in excess of the base policy premium is contributed to the trust during a predetermined time period, an election is made under Internal Revenue Code 83(b) by an insured to include such excess amount in the insured's gross income.

7. A system under which an insurer will provide death benefits to employees of an employer, the system comprising:
a participating whole life insurance policy configured to provide death benefits to an employee under a single welfare benefit plan, the participating whole life insurance policy having a contract premium and a paid-up addition;
a qualified direct cost based solely on the contract premium, the qualified direct cost being an amount equal to a required annual payment to pay a current cost of the death benefits established by the whole life insurance policy; and
a trust agreement between the employer and employee, wherein the employer provides welfare benefits to the employee and to designated beneficiaries of the employee through the trust agreement.

8. The system of claim 7, wherein the trust comprises a welfare benefit fund that represents funds necessary to provide a death benefit coverage and a non-welfare benefit fund that represents Section 83 property.

9. The system of claim 7, wherein the paid-up addition constitutes transfer of property to the employee within the meaning of Internal Revenue Code Sections 402 and 83.

10. The method of claim 7, further comprising executing a restricted property agreement between the employer and the employee.

11. An insurance product under which an insurer provides death benefits to an employee of an employer, comprising:
at least one irrevocable welfare benefit trust, the at least one trust being funded with a contribution from the employer;
a whole life insurance policy owned by the at least one trust, wherein a base premium cost of the policy qualifies as a qualified direct cost within the meaning of IRC Section 419(c)(3); and
a restricted property agreement executed between the employer and the employee, wherein the employee incurs a substantial risk of forfeiture within the meaning of IRC Section 83.

12. The insurance product of claim 11, wherein a beneficiary of the whole life insurance policy is designated by the employee.

13. The insurance product of claim 11, wherein a third party independent of the employer and employee serves as a trustee of the at least one trust.

14. The insurance product of claim 11, wherein the employer makes the contribution to the at least one trust on a yearly basis.

15. The insurance product of claim 14, wherein a term of the restricted property agreement provides that the yearly contributions made to the at least one trust cover the base policy premium.

16. The insurance product of claim 11, wherein the contribution from the employer includes the base premium cost and paid-up additions, the base premium cost being the qualified direct cost and the paid-up additions constituting a transfer of property to the employee within the meaning of IRC Section 83.

17. The insurance product of claim 16, wherein the qualified direct cost portion is deductable pursuant to IRC Sections 162 and 419 and wherein the Section 83 property portion is deductable pursuant to IRC Sections 162 and 83.

18. The insurance product of claim 11, wherein at least a portion of the employer's contribution is subject to split-dollar regulations under Treasury Regulation Section 1.61-22.
